(19) United States
(12) Patent Application Publication
(10) Pub. No.: US 2003/0079295 A1
(43) Pub. Date: May 1, 2003

(54) Hand tool assembly

(75) Inventor: Ramond Ho, Changhua city (TW)

Correspondence Address: BACON & THOMAS, PLLC, 625 SLATERS LANE, FOURTH FLOOR, ALEXANDRIA, VA, 22314

(73) Assignee: Ye Chou Industry Co., Ltd, Changhua City (TW)

(21) Appl. No.: 09/984,524

(22) Filed: Oct. 30, 2001

(51) Int. Cl. B25B 13/00

(52) U.S. Cl. 7/138

(57) ABSTRACT

A m ulti-purpose hand tool assembly is equipped with a spring biased pressing button having a downwardly bent lateral edge which can be in firm registration with a retaining cut of a selective tool bit so as to make the tool bit held in place when external force is applied thereto. The pressing button is pivotally fixed in place by a pivot pin to the hand tool assembly. A plurality of tool bits, such as a screw driver, a knife, a spanner and etc., are pivotally mounted onto a bolt locked in place by a nut at one end of the hand tool assembly. Each tool bit has an end provided with a working head and an opposite end equipped with a mounting hole through which the bolt is led so as to permit the multiple tool bits to be selectively pivoted about the bolt. At the pivot end of each bit is disposed at least the retaining cut which can be registered with the downwardly bent retaining end so as to firmly hold each selective tool bit in an operation position. A chain remover head having two retaining cuts at the pivot end thereof is additionally mounted onto the bolt of the hand tool assembly. Such a structure permits the tool bits to be firmly held in position when force is applied to the hand tool assembly.

### BACKGROUND OF THE INVENTION

The present invention relates to a multi-purpose hand tool assembly, which is equipped with a spring biased pressing button having a downwardly extended lateral retaining edge at one end. The retaining edge of the spring biased pressing button can be in firm registration with a retaining cut of a selective tool bit so as to make the tool bit held in place when an external force is applied thereto. The pressing button is pivotally fixed in place by a pivot pin to the hand tool assembly. The pressing button is pivotally fixed in place. A plurality of tool bits, such as a screw driver, a knife, a spanner and etc., are pivotally mounted onto a bolt locked in place by a nut at one end of the hand tool assembly. Each tool bit has an end provided with a working head and an opposite end equipped with a mounting hole through which the bolt is led so as to permit the multiple tool bits to be selectively pivoted about the bolt. At the pivot end of each bit is disposed at least a retaining cut which can be registered with the downwardly bent retaining edge so as to firmly hold each selective tool bit in an operation position. A chain remover head having two retaining cuts at the pivot end thereof is additionally mounted onto the bolt of the hand tool assembly. Such a structure permits the tool bits to be firmly held in position when force is applied to the hand tool assembly.

Referring to FIG. 1, a prior art hand tool assembly 10 has a pair of locking boards 11, a pair of supporting boards 12, a plurality of tool bits 13, a plurality of washers 14, two bolts 15, two nuts 16 and a stop stick 17. The locking boards 11 are long plastic boards having at each end a countersunk hole 111. The supporting boards 12 in similar shape as the locking boards 11 have respectively a pair of through holes 121 at each end with the stop stick 17 disposed therebetween. Each tool bit 13 has an arc shaped mounting section 131 at one end and a working tool head 132 at the other end, such as a cross-ended screwdriver, a 1 shape-ended screwdriver, a hexagonended shank. It is assembled by first leading the pivot bolt 15 via the countersunk hole 111 of the locking board 11 and the through hole 121 of the supporting board 12 with the large end of the bolt 15 embedded in the countersunk hole 111; then a washer 14 being putting onto the bolt 15 with a mounting section 131 of a tool bit 13 engaged with the bolt 15. Afterwards, washers 14 and tool bits 13 are sequentially mounted onto the bolt 15 and another locking board 11 and supporting board 12 are finally engaged with the small end of the bolt 15 with a nut 16 registered with that end in the countersunk hole 111 of the locking board 11. The working tool heads 132 of the tool bits 13 are located at both ends of the hand tool assembly 10.

There are several disadvantages given as below:

1. The hand tool assembly 10 has a plurality of tool bits 13 and washers 14 that are locked in place between the locking boards 11 and supporting boards 12 by bolts 15 and nuts 16. The tool bits 13 not designed to be retained in position by any means are easily slipped off working spots, resulting in hurting of hands of a user.

2. The tool bits 13 can not be held in position and are easily pivoted away when force is applied thereto, the tool bits must be held with effort.

3. The bolts 15 are easily loosened as a result of frequent use of the hand tool assembly and must be tightened regularly.

4. The hand tool assembly 10 is fixed in structure and another hand tool assembly 10 must be resorted when a hand tool bit 13 is not available in a first tool assembly 10.

### SUMMARY OF THE INVENTION

Therefore, the primary object of the present invention is to provide an improved hand tool assembly equipped with a spring biased pressing button which has a downwardly extended edge for locking a tool bit in place. Each tool bit has at least a retaining cut at its pivot end to engage with the extended retaining edge of the pressing button so as to firmly hold a tool bit when a user applies force on the hand tool assembly.

Another object of the present invention is to provide a hand tool assembly which can be used to pry a wheel cover open in dismantling vehicle's wheels.

One further object of the present invention is to provide a hand tool assembly which has a chain remover and can work in combination with another set of hand tool assembly to get a chain dismantled.

One still further object of the present invention is to provide a hand tool assembly which can be used to pry a wheel cover open in dismantling vehicle's wheels.

### BRIEF DESCRIPTION OF THE DRAWINGS

FIG. 1 is a perspective diagram showing a prior art structure;

FIG. 2 is a perspective diagram showing the exploded components of the present invention;

FIG. 3 is a perspective diagram showing the assembly of the present invention;

FIG. 4 is a diagram showing the operation mode thereof;

FIG. 5 is a diagram showing another operation mode thereof;

FIG. 6 is a diagram showing the present invention in combination with a tool bit;

FIG. 7 is a partially sectional diagram of the combination of the present invention with another hand tool assembly;

FIG. 8 is a sectional diagram showing the combination of two fixing seats of the present invention.

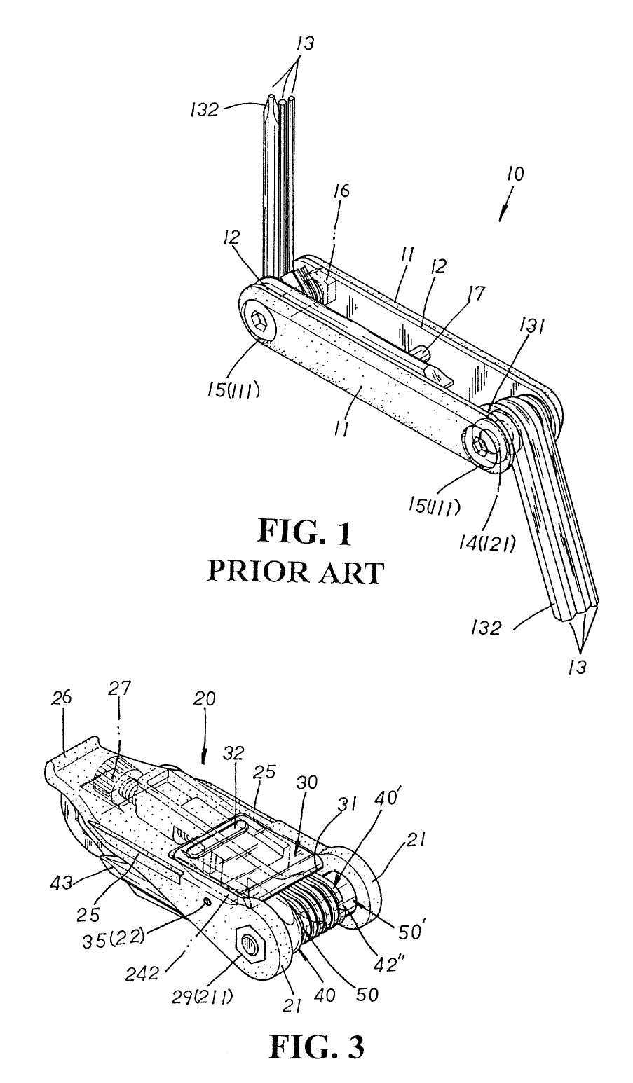

### DETAILED DESCRIPTION OF THE PREFERRED EMBODIMENTS

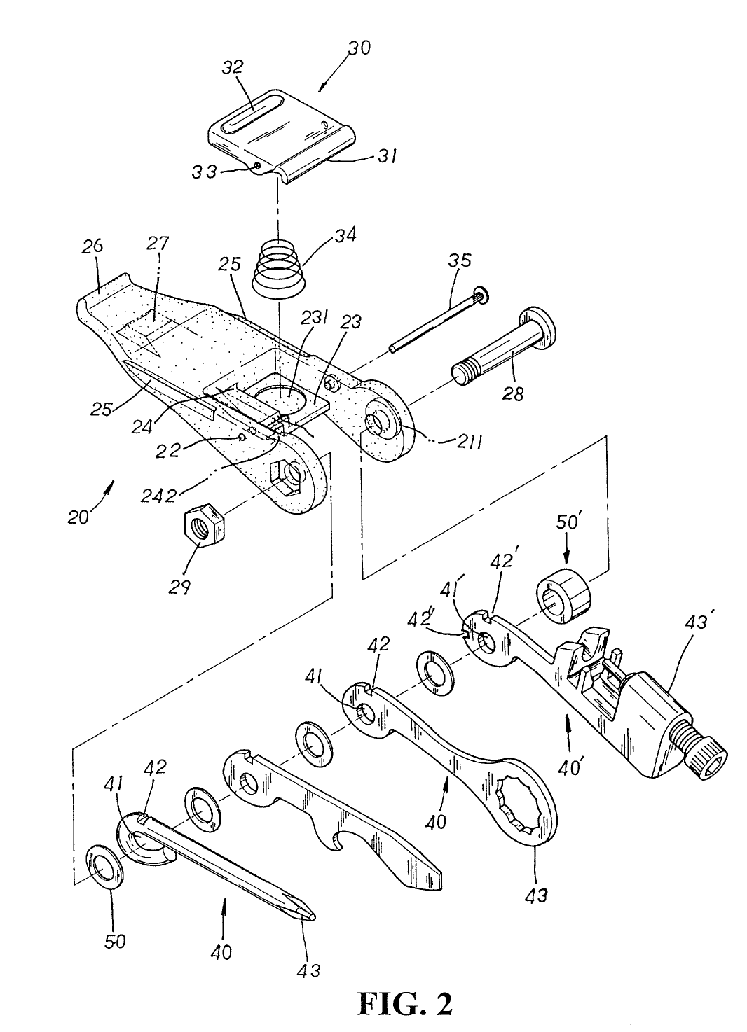

Referring to FIG. 2, the hand tool assembly of the present invention comprises a fixing seat 20, a screw-ended pivot bolt 28, a nut 29, a pressing button 30, a bias spring 34, a pivot pin 35, a plurality of tool bits 40, a chain remover 40′, a plurality of washers 50 and a thick washer 50′.

The fixing seat 20 is a plate like form and has a pair of parallel fixing plate lugs 21 with countersunk holes 211 defined on each lug 21 at the front end thereof. A pair of through holes 22 are located at a distance from the countersunk holes 211. A receiving cavity 23 is defined between the fixing plate lugs 21 with a shallow recess 231 defined at the bottom of the receiving cavity 23. On one side of the receiving cavity 23 is disposed a stepwise partition seat 24 with an arc shaped groove 241 defined on the top with a receiving recess 242 of the same shape disposed at the bottom thereof. A long engagement groove 25 is defined at the middle position of each side of the fixing seat 20 with a narrowed and upwardly bent edge 26 at the other end of the fixing seat 20. On the underside of the upwardly bent section of the fixing seat 20 is disposed a long cavity 27. The pressing button 30 has a downwardly extended retaining edge 31 at one end and a pressing section 32 at the other end. Extending from the retaining edge 31 toward the center is disposed an abutment projection with a through hole 33 defined thereon of the passage of the pivot pin 35 to permit the pressing button 30 to pivot back and forth. each of the hand tool bit 40 has a mounting section at one end and a tool head 43 at the other end, such as a hexagon-headed shank, a cross-headed screw driver, an l-shape headed screw driver, a knife and etc. and a chain remover 40′ having a through hole 41′ at the mounting section at one end thereof and retaining cuts 42′, 42″ defined thereon. A chain removing head 43′ disposed at the front end of the chain remover. Each mounting section of the hand tool bits 40 has a through hole 41 for the passage of the screw-ended pivot bolt 28; on the mounting section is disposed at least a retaining cut 42.

Referring to FIG. 3, when the components of the hand tool assembly are put together piece by piece, the screw-ended rod 28 is led through the countersunk hole 211 of one of the fixing plate lugs 21 of the fixing seat 20. Then the screw-ended pivot bolt 28 is guided sequentially through a plurality of washers 50 and the through holes 41, 41′ of the tool bits 40 and the chain remover 40′ and further through a thick washer 50′. At last the screw-ended section of the pivot bolt 28 is located in the countersunk hole 211 of the opposite fixing plate lug 21 of the fixing seat 20 and locked in place by a nut 29. The length of the pivot bolt 28 is as long as the width of the fixing seat 20. The bottom end of the spring 34 is placed in the shallow recess 231 of the receiving cavity 23 with a housing space defined between one of the fixing plate lugs 21 and the partition seat 24 in connection to the other fixing plate lug 21. The pressing button 30 placed in the cavity 23 and in abutment against the spring 34 has its downwardly extended retaining edge 31 selectively engaged with the retaining cut 42 of the hand tool bits 40. The pressing button 30 is constantly urged by the spring 34 to cause the retaining edge 31 in abutment against the mounting section of each tool bit 40. The through holes 33 at both longitudinal sides of the pressing button 30 are located in line with the through holes 22 of the fixing seat 20 so as to permit the pivot pin 35 to be led via the through hole 22 and the groove 241 of the partition seat 24 and engaged with the other through hole 22 at final. The pivot pin 35 is firmly held in place by the parallel ditches at one end.

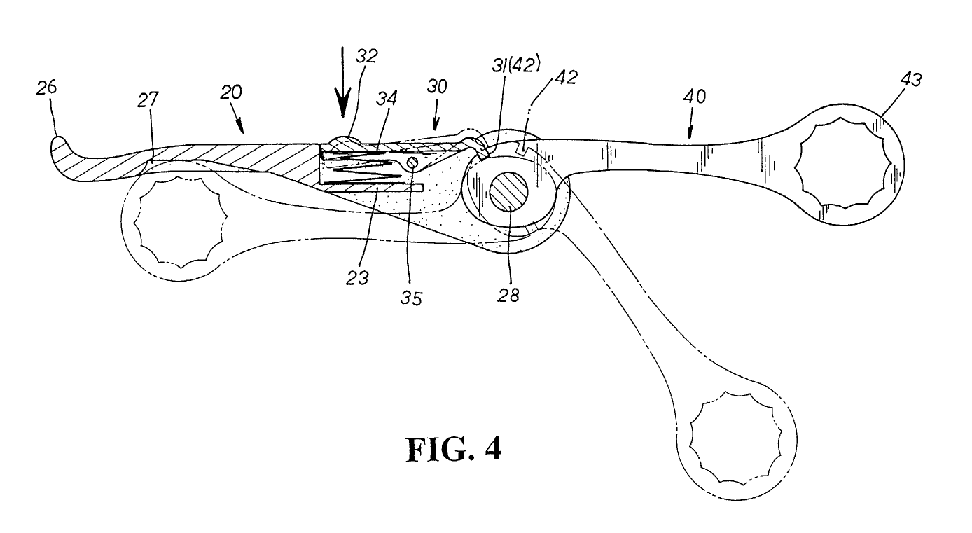

Referring to FIG. 4, the operation mode of the present invention is shown. To use the hand tool, one of the tool bits 40 is pivoted about the rod 28 from the bottom of the fixing seat 20. In rotation, the spring 34 is in resilient abutment against the pressing button 30 and the smoothly curved mounting section of the tool bit 40 is in abutment against the retaining edge 31 of the pressing button 30. On the retaining cut 42 coming into registration with the retaining edge 31 of the pressing button 30 as a result of the pivot rotation of the tool bit 40, the same is held in position firmly.

To release the tool bit 40 from restraint, the pressing end 32 of the pressing button 30 is pushed down to make the pressing button 30 pivot about the pivot pin 35, resulting in the disengagement of the retaining edge 31 of the pressing button 30 from the retaining cut 42 of the tool bit 40. The mounting section of the tool bit 40 can be in smooth rotation contact with the retaining edge 31 in collection operation. The bit head 43 of the tool bit 40 can be respectively in close abutment against the long cavity 27 of the fixing seat 20. In case of the tool bit 40 being a knife, the plate-like body of the knife can be received in the long receiving recess 242 defined at the bottom of the fixing seat 20.

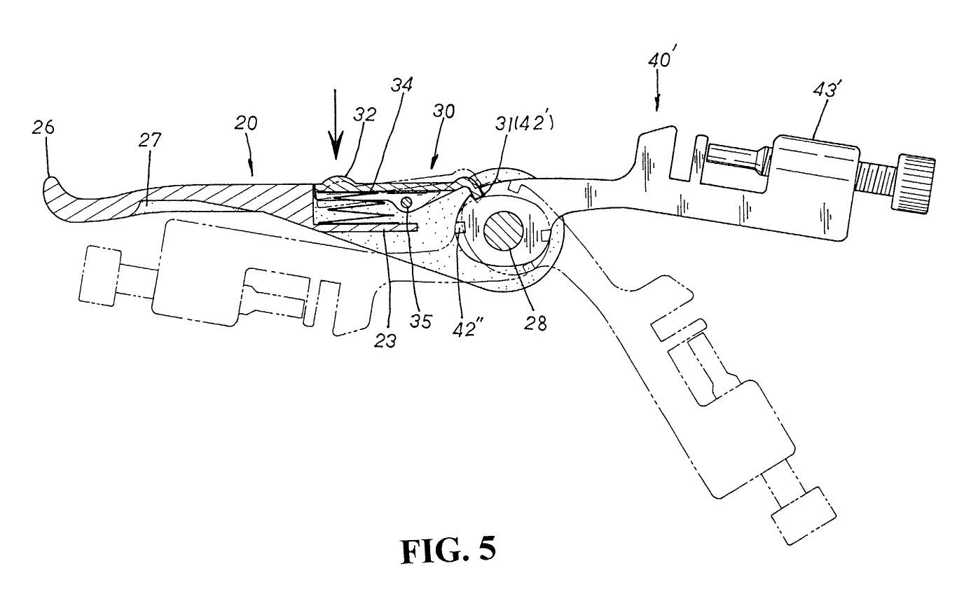

Referring to FIG. 5, in operation, the chain remover 40′ is pivoted about the pivot bolt 28 from the bottom of the fixing seat 20. In the same manner as described above, the mounting section of the chain remover 40′ has two retaining cuts 42′, 42″. The retaining edge 31 of the pressing button 30 is first engaged with the retaining cuts 42″ when the chain remover 40′ is pivoted about the pivot pin 35 for a user to operate on a chain in combination with another hand tool bit. When the chain remover 40′ continues to rotate to fully extend, the retaining edge 31 of the pressing button 30 comes into engagement with the other retaining cut 42″ for further operation on a chain to dismantle the same. To make the chain remover collected, the pressing section 32 of the pressing button 30 is pushed down to get the retaining edge 31 thereof released from the engagement with the retaining cut 42 of the chain remover 40′. At then the arc shaped mounting section of the chain remover 40′ is in smooth contact with the retaining edge 31 of the pressing button 30 in the collection.

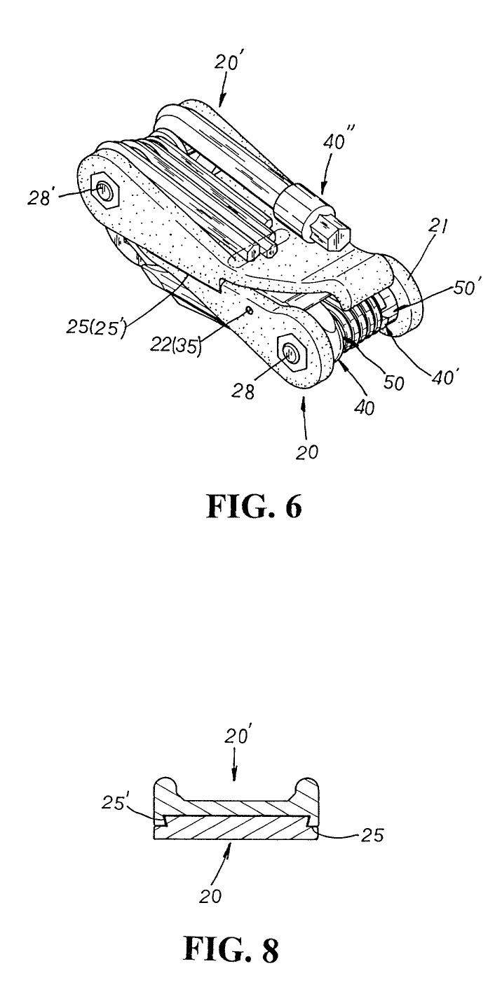

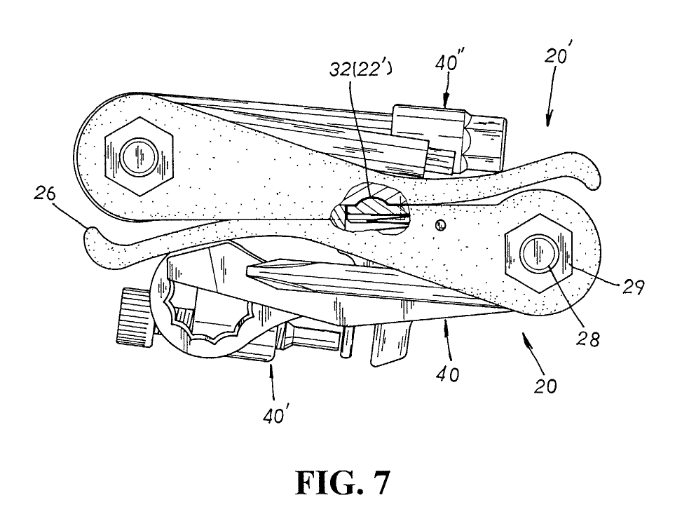

Referring to FIG. 6, it illustrates two hand tool sets being integrally combined as one. In FIGS. 7, 8, the sectional views show the details of that combination. The fixing seat 20 has a long female engagement recess 25 at each side thereof which can be in locking registration with a male retaining edge 25′ on each longitudinal side of another fixing seat 20′. The lateral restraint groove 22′ on the underside of the fixing seat 20′ can be registered with the pressing section 32 of the pressing button 30 of the fixing seat 20 whereby a firm combination of two hand tool sets can be integrated as one. The tool bits used to lock the pivot bolts 28, 28′ in place are mounted onto respective hand tool assemblies so that the tool bits 40, 40′ can tighten the pivot bolts 28, 28′ in position when they are loosened due to frequent usage.

Several advantages apparently associated with the hand tool assembly of the present invention are given as below:

1. The fixing seat 20 is equipped with a pivotal pressing button 30 having a downwardly extended retaining end 31 which can be in retaining engagement with a retaining cut 42 of a hand toot bit 40 whereby when a force is applied to the tool bit 40, it will not be loosely shifted from its operation position, putting the user's band in jeopardy of accidental hurting.

2. As the hand tool bits 40 are firmly retained in place with respect to the fixing seat 20 without moving randomly, a user can hold the fixing seat 20 with ease in operation of the hand tool assembly.

3. When the pivot bolts 28, 28′ are loosened, corresponding hand tool bits 40, 40′ of two hand tool assemblies can be used to tighten the same.

4. The chain remover 40′ has retaining cuts 42′, 42″ can be combined with another chain remover to make the chain removing operation easy and convenient.

5. Two hand tool assemblies can be integrated together by female engagement recesses 25 of one fixing seat 20 and male engagement edges 25′ of another fixing seat 20′ with the pressing section 32 of the pressing button 30 of the fixing seat registered with a lateral groove 22′ of the fixing seat 20′ so as to obtain a multiple purposed hand tool assembly.

I claim:

1. A hand tool assembly comprising a fixing seat, a pivot bolt, a pressing button, a bias spring, a pivot pin, a plurality of hand tool bits, a chain remover, a plurality of washers and a thick washer wherein:
said fixing seat has one end provided with a pair of parallel lugs adapted for pivotally securing a plurality of said hand tool bits and washers and said thick sequentially onto said pivot bolt which is mounted to said fixing seat by a nut so as to permit said hand tool bits to be selectively pivoted for use or collection; a through hole is disposed on each said lug for mounting of said pivot pin to which said pressing button is pivotally secured; a receiving cavity with a shallow recess is disposed between said lugs for housing said bias spring; on top of said bias spring is pivotally located said pressing button which is biased by said spring to lean to and in contact with said hand tool bits;
said pressing button has an downwardly retaining edge in urging contact with said hand tool bits at one end and a pressing section at the other end; at each axial side of said pressing button is disposed a through hole for location of said pivot pin;
each said hand tool bit has a mounting section at one end and a tool head at the other end; each said mounting section has a through hole for the passage of said pivot bolt; on said mounting section is disposed a retaining cut;
said chain remover has one end provided with a mounting section and the other end with a chain removing means;
whereby said retaining edge of said pressing button is in smooth contact with said mounting section of said hand tool bits with the help of said bias spring and is engaged with said retaining cut when each said hand tool bit is pivoted to extend for use; and said retaining edge of said pressing button is released from the engagement of said retaining cut when said pressing section of said pressing button is forced downwardly.

2. The hand tool assembly as claimed in claim 1 wherein said retaining cut disposed on said mounting section of each said hand tool bit can be one or more than one.

3. The hand tool assembly as claimed in claim 1 wherein under said fixing seat are disposed a receiving recess and long cavity which is located near a front end of the fixing seat adapted for receiving tool heads of said hand tool bits.

4. The hand tool assembly as claimed in claim 1 wherein said upper bent edge of said fixing seat is used to dismantle wheels of vehicles.

5. The hand tool assembly as claimed in claim 1 wherein said chain remover is applied to dismantle chains.

6. The hand tool assembly as claimed in claim 1 wherein said pressing section of said pressing button is engaged with a lateral groove disposed under said fixing seat; and said fixing seat has a pair of male engagement grooves on each side of the underside thereof that are engageable with a pair of female engagement edges disposed on each side of another fixing seat whereby two hand tool assemblies can be combined with each other to obtain a hand tool of multiple functions.
